(19) United States
(12) Patent Application Publication
(10) Pub. No.: US 2011/0050662 A1
(43) Pub. Date: Mar. 3, 2011

(54) DISPLAY

(75) Inventor: Wen Shih Chen, Taipei (TW)

(73) Assignee: Fujitsu Technology Solutions Intellectual Property GmbH, Munich (DE)

(21) Appl. No.: 12/862,063

(22) Filed: Aug. 24, 2010

(30) Foreign Application Priority Data
Aug. 27, 2009 (EP) 09168851.5

(51) Int. Cl. G09G 3/36; G09G 5/10

(52) U.S. Cl. 345/207; 345/87

(57) ABSTRACT

A display includes a housing including a frame, a panel fixedly arranged inside the frame and including a front pane which presents a picture visible in a viewing area substantially in front of the front pane, a sensor fixedly coupled to the housing and arranged in the viewing area in front of the front pane which receives at least one spectral radiation component of the picture emitted by the panel, and wherein the sensor is fixed on the frame such that it receives visible radiation of a surrounding area of the display.

### RELATED APPLICATION

This application claims priority of European Patent Application No. 09168851.5, filed Aug. 27, 2009, herein incorporated by reference.

### TECHNICAL FIELD

This disclosure relates to a display which is, for example, used for televisions or personal computers. Such displays may loose luminosity during their lifetime.

### BACKGROUND

US 2009/0160834 A1 discloses a display screen with a display area which includes a frame and a sensor module. The frame surrounds the display area. The sensor module is mounted on the frame and includes a mount disposed on the frame and a slidable assembly slidably disposed on the mount and including an ambient light sensor and a screen light sensor, wherein the ambient light sensor and the screen light sensor are disposed on two opposite sides of the slidable assembly respectively.

US 2001/0008395 A1 discloses an image display device. The image display device has a sensor which measures how R, G, and B light is emitted to display an image on a display panel. According to the measurement value obtained from the sensor, the power with which to drive a light source that supplies light needed for the display operation of the display panel is varied so that the brightness or chromaticity of the display panel is corrected.

EP 1 274 066 A1 discloses a system and method for real time correction of light output and/or color of an image displayed on a display device. The system comprises: a display device comprising an active display area for displaying the image, an image forming device and an electronic driving system for driving the image forming device, an optical sensor unit comprising an optical aperture and a light sensor having an optical axis, to make optical measurements on a light output from a representative part of the active display area of the image forming device and generating optical measurement signals therefrom, a feedback system receiving the optical measurement signals and on the basis thereof controlling the electronic driving system.

It could be helpful to provide a display with a constant luminosity during the whole lifetime of the display.

### SUMMARY

I provide a display including a housing including a frame, a panel fixedly arranged inside the frame and including a front pane which presents a picture visible in a viewing area substantially in front of the front pane, a sensor fixedly coupled to the housing and arranged in the viewing area in front of the front pane which receives at least one spectral radiation component of the picture emitted by the panel, and wherein the sensor is fixed on the frame such that it receives visible radiation of a surrounding area of the display.

### BRIEF DESCRIPTION OF THE DRAWINGS

FIG. 1 shows a display in a perspective view;

FIG. 2 shows an enlarged representation of a panel of the display in a schematic view;

FIG. 3 shows a further enlarged representation of the panel in a sectional view; and

FIG. 4 shows a control unit and the panel of the display in a schematic view.

### DETAILED DESCRIPTION

It will be appreciated that the following description is intended to refer to specific examples of structure selected for illustration in the drawings and is not intended to define or limit the disclosure, other than in the appended claims.

My display comprises a housing and a panel. The panel is fixedly arranged inside the housing and comprises a front pane. The front pane is designed for presentation of a picture visible in a room area in front of the front pane. A sensor is fixedly coupled to the housing or to the panel. The sensor is arranged in the room area in front of the front pane and is designed to receive the intensity of at least one spectral radiation component of the picture emitted by the panel. The housing comprises a frame. The panel is arranged inside the frame and the sensor is fixedly arranged on the frame. The sensor is arranged and designed to receive the intensity of the visible radiation of a surrounding area of the display.

In particular, the sensor is positioned in an area in which the picture emitted by the display may be seen totally or at least partially.

This has the advantage that the luminosity of the at least one spectral radiation component may be kept constant during the whole life-time of the display by directly controlling the luminosity of the picture as it can be seen by the viewer. A further advantage is that the whole front surface of the panel may be used by the viewer in an undisturbed manner and without obstacles. A further advantage is that the luminosity of the panel may be adapted to the luminosity of the surrounding area of the display.

The panel may comprise a plurality of pixels. Each of the pixels comprises base color pixels for the emission of three base colors. The sensor is designed to receive the intensity of the spectral radiation component of at least one of the three base colors of the picture. The luminosity of one or more of the three base colors may be kept constant during the whole life-time of the display.

The panel may also comprise a plurality of pixels. Each of the pixels comprises base color pixels for the emission of three base colors. The sensor is designed to receive the intensity of the sum of the spectral radiation components of the three base colors of the picture. The luminosity of the sum of the spectral radiation components of the three base colors may be kept constant during the whole life-time of the display.

The panel may further comprise a plurality of pixels. The pixels are designed for the emission of a mixing color. The sensor is designed to receive the intensity of the radiation component of the mixing color of the picture. In particular, the mixing color may be the color “white” which may be preferably used in black-white displays. This has the advantage that the luminosity of the mixing color may be kept constant during the whole life-time of the display.

The display may have a signal input which is designed for the input of a video signal, and a control unit. The control unit is electrically coupled with the signal input and is designed to control the luminosity of the panel depending on the video signal. The sensor is designed for the output of at least one output signal representative for the intensity of the at least one spectral radiation component of the picture and/or for the intensity of the visible radiation of the surrounding area of the display. The sensor is electrically coupled to the control unit. The control unit is designed to control the panel depending on the at least one output signal of the sensor.

The luminosity of the panel may thus be kept constant after the start or an operation break of the display.

The panel may be a liquid crystal panel.

Turning now to the drawings, elements of the same design and function that occur in different illustrations are identified by the same reference character.

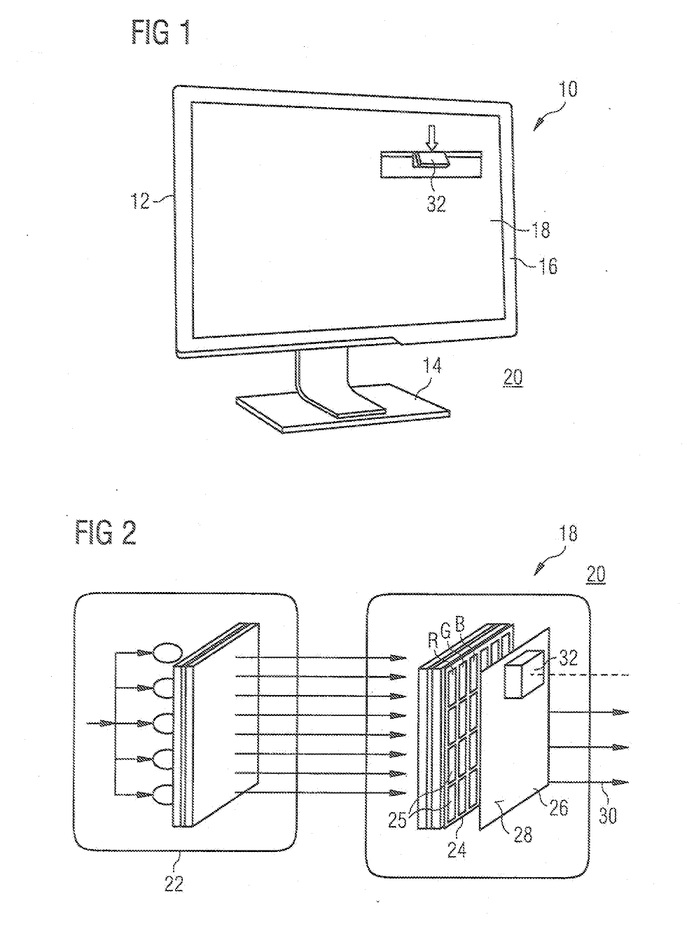

FIG. 1 shows a display 10. The display 10 is designed as a flat screen display. However, the display 10 may be in other forms known in the art.

The display 10 has a housing 12 which is mechanically coupled to a base 14. The base 14 carries the display 10. The housing 12 has a frame 16. A panel 18 is fixedly arranged inside the frame 16. In FIG. 1, the panel 18 is a liquid crystal panel.

The display 10 is arranged, located or positioned in a surrounding or viewing area 20.

FIG. 2 shows the panel 18 which is designed as a liquid crystal panel in an enlarged representation. The panel 18 designed as a liquid crystal panel has a background lighting 22. Radiation emitted by the background lighting 22 is received by a liquid crystal cell 24. The liquid crystal cell 24 comprises a plurality of pixels 25. In FIG. 2, the pixels 25 comprise basic color pixels R, G, B, which are in particular designed to emit three basic colors red, green and blue. By applying a voltage to the pixels 25 of the crystal liquid cell 24 the direction of polarization of the pixels 25 may be changed individually. By this a transmission of the radiation of the background lighting 22 or a shading of the radiation of the background lighting 22 can be obtained for the basic color pixels R, G, B.

The panel 18 furthermore has a front pane 26 with a front surface 28. The front pane 26 may present a picture. The front pane 26 is designed for the transmission of at least one spectral radiation component 30. The spectral radiation component 30 is a portion of the visible spectrum of the light.

In FIG. 2, the front pane 26 comprises a sensor 32 which is arranged on the front surface 28. By this, the sensor 32 is fixedly coupled to the panel 18. The functions of the sensor 32 will be described in the following in detail.

In the display 10 shown in FIG. 1, the sensor 32 is fixedly arranged on the frame 16. By this, the sensor 32 is fixedly coupled to the housing 12.

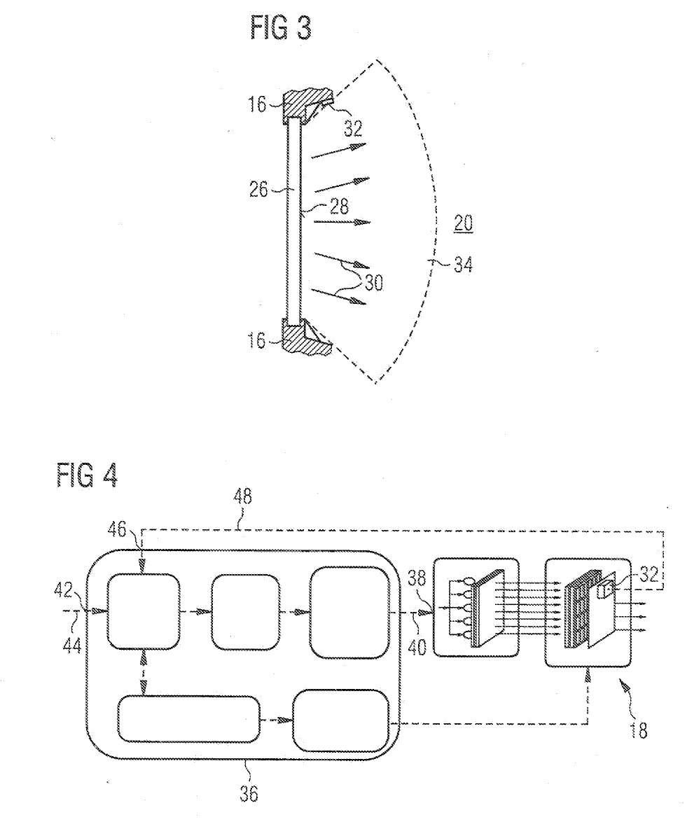

FIG. 3 shows a schematic view of a part of the display 10. The panel 18 is emitting visible spectral radiation components 30 of the picture through the front surface 28 of the front pane 26 into a room area 34 in front of the front pane 26. The room area 34 in front of the front pane 26 is the area in which a viewer may watch the picture on the panel 18. This means that the picture presented by the panel 18 may be visible in the whole room area 34 in front of the front pane 26.

In the display 10 shown in FIG. 1, the sensor 32 is fixedly arranged on the frame 16.

The sensor 32 may receive the intensity of at least one component 30 of the visible radiation of the picture emitted by the panel 18. Furthermore, the sensor 32 may preferably receive the intensity of the visible radiation of a surrounding area 20 of the display 10.

Preferably, the sensor 32 can receive the intensity of one of the three basic colors of the radiation components 30 of the picture emitted by the panel 18.

Further preferably, the sensor 32 may receive the intensity of the sum of the emitted spectral radiation components 30 of the picture emitted by the panel 18. In particular, the sensor 32 may receive the intensity of the sum of the emitted spectral radiation components 30 of the basic color pixels R, G, B.

Further preferably, the pixels 25 are designed to emit a mixing color. In this case, it is advantageous if the sensor 32 may receive the emitted spectral radiation components 30 of the picture emitted by the panel 18. In particular, the mixing color may be the color “white.” This color is preferably used with black-white panels.

FIG. 4 shows the panel 18 and a control unit 36. The panel 18 is electrically coupled to the control unit 36 by control lines and a signal input 38. A video signal 40 from the control unit 36 can reach the panel 18 via the signal input 38. The control unit 36 may control the luminosity of the panel 18 depending on the properties of the video signal 40.

The control unit further comprises a PC input 42. A PC signal 44 can reach the control unit 36 for the controlling of the panel 18 via the PC input 42.

The control unit 36 comprises a further signal input 46. An output signal 48 of the sensor 32 can reach the control unit 36 by the further signal input 46. The output signal 48 of the sensor 32 or the output signals 48 of the sensor 32 respectively are representative for the intensity of the spectral radiation components 30 of the picture emitted by the panel 18 and/or for the intensity of the visible radiation of the surrounding area 20 of the display 10. The control unit 36 may control the luminosity of the panel 18 depending on the at least one output signal 48 of the sensor 32.

The panel 10 has the advantage that the total luminosity of the radiation components 30 or the luminosity of one or more of the basic colors red, green or blue emitted by the display 10 may have a high stability over the lifetime of the display 10. Depending from the output signal 48 of the sensor 32 with a value which is a measure for the intensity of the radiation components 30 emitted by the panel 18 via the front surface 28 of the front panel 26 the pixels 25 and/or the basic color pixels R, G, B may be controlled by the control unit 36. Thus, a high stability of the total luminosity or a high stability of the luminosity of one or more of the basic colors red, green or blue may be obtained over the lifetime of the display 10.

By receiving the intensity of the visible radiation of the surrounding area 20 of the display 10 it is possible to control the pixels 25 and/or the basic color pixels R, G, B. Therefore, the intensity of the radiation components 30 of the picture may be adapted depending on the intensity of the lightning of the surrounding area 20 of the display 10.

A further advantage of the display 10 is that in view of professional applications such as medical, CAD/CAM and/or graphic applications, there is a high capability to maintain a very good image performance consistently over the lifetime of the display 10. In particular, a stabilization of the real time brightness over the lifetime of the display 10 is possible. Furthermore, control of the color chromaticity in a very narrow tolerance band is possible. Furthermore, an adjustment of the display 10 as a function of the illumination in the surrounding area 20 is possible. Finally, it is possible to verify and recalibrate the gamma curve and obtain the standards of digital imaging and communications in medicine (DICOM). DICOM is a standard to adjust the Gray scale tone characteristics of displays used in the medical field. An image performance track in the calibration may be carried out without additional hardware or further tools. An incorporated luminance and color engine may automatically adjust related parameters. Stabilization of luminance may be possible within a very short time period of, for example, a few seconds after the start-up of the display 10. Image luminance drift problems during a warm-up period of the panel 18 may be avoided. The luminance output value may be set according to the preference of the end user if the preset luminance is not satisfactory for the application.

Although the apparatus and has been described in connection with specific forms thereof, it will be appreciated that a wide variety of equivalents may be substituted for the specified elements described herein without departing from the spirit and scope of this disclosure as described in the appended claims.

### REFERENCES

10 display
12 housing
14 base
16 frame
18 panel
20 surrounding area
22 back ground lightning
24 liquid crystal cell
25 pixels
26 front pane
28 front surface
30 radiation component
32 sensor
34 room area
36 control unit
38 signal input
40 video signal
42 PC input
44 PC signal
46 further signal input
48 output signal of 32
R,G,B basic colour pixel

1. A display comprising:
a housing comprising a frame,
a panel fixedly arranged inside the frame and comprising a front pane which presents a picture visible in a viewing area substantially in front of the front pane,
a sensor fixedly coupled to the housing and arranged in the viewing area in front of the front pane which receives at least one spectral radiation component of the picture emitted by the panel, and wherein the sensor is fixed on the frame such that it receives visible radiation of a surrounding area of the display.

2. The display according to claim 7, wherein the panel comprises a plurality of pixels, each pixel comprising base color pixels (R, G, B) for emission of three base colors, and the sensor receives the spectral radiation component of at least one of the three base colors of the picture.

3. The display according to claim 1, wherein the panel comprises a plurality of pixels, each pixel comprising base color pixels (R, G, B) for emission of three base colors, and the sensor receives a sum of the spectral radiation components of the three base colors of the picture.

4. The display according to claim 1, wherein the panel comprises a plurality of pixels, the pixels designed for emission of a mixing color composed of base colors, and the sensor receives a radiation component of the mixing color of the picture.

5. The display according to claim 1, further comprising:
a signal input that inputs a video signal; and
a control unit electrically coupled with the signal input and which controls luminosity of the panel depending on the video signal,
wherein the sensor outputs at least one output signal representative of intensity of the at least one spectral radiation component of the picture and/or intensity of the visible radiation of the surrounding area of the display, and wherein the sensor is electrically coupled to the control unit, and the control unit controls the panel depending on the at least one output signal of the sensor.

6. The display according to claim 1, wherein the panel is a liquid crystal panel.
